(19) United States
(12) Patent Application Publication
(10) Pub. No.: US 2017/0151940 A1
(43) Pub. Date: Jun. 1, 2017

(54) HYBRID VEHICLE

(71) Applicant: Toyota Jidosha Kabushiki Kaisha, Toyota-shi Aichi-ken (JP)

(72) Inventors: Takuma Nakamura, Nisshin-shi (JP); Naoki Ishikawa, Tokai-shi (JP)

(21) Appl. No.: 15/355,427

(22) Filed: Nov. 18, 2016

(30) Foreign Application Priority Data
Dec. 1, 2015 (JP) 2015-234697

(51) Int. Cl. B60W 20/15; B60W 10/18; B60W 10/115; B60W 50/14; B60W 10/06; B60W 10/08

(52) U.S. Cl. CPC B60W 20/15; B60W 10/06; B60W 10/08; B60W 10/115; B60W 50/14; B60W 10/18; B60W 2540/12; Y10S 903/947; Y10S 903/945

(57) ABSTRACT

An ECU performs control processing including setting a recommended gear position when a manual shift change mode has been set, calculating an estimated value for regenerative electric power during off of an accelerator when a current gear position is equal to or higher than the recommended gear position, when the accelerator is on, and when a catalyst is being warmed up, and providing an up-shift representation when magnitude of the estimated value is greater than upper limit charging power Win and when the up-shift representation is not prohibited.

### CROSS-REFERENCE TO RELATED APPLICATIONS

This application claims priority to Japanese Patent Application No. 2015-234697 filed on Dec. 1, 2015, the entire contents of which are hereby incorporated by reference.

### BACKGROUND

Field

The present disclosure relates to control of a hybrid vehicle which can decelerate with at least one of braking torque resulting from regeneration and friction torque of an engine.

Description of the Background Art

Japanese Patent Laying-Open No. 10-094107 discloses a hybrid vehicle which applies, during deceleration of the vehicle, braking resulting from regeneration in an MG2 and braking making use of friction rotational resistance of an engine (that is, engine braking), based on a state of charge of a battery.

For such a hybrid vehicle, a configuration in which a user can select a simulatively set gear position or a gear position of a speed changing device so that a vehicle is controlled with a rate of deceleration set in accordance with the selected gear position being defined as a target value has been known.

### SUMMARY

A catalyst which purifies an exhaust gas may be provided in an exhaust path in an engine mounted on a hybrid vehicle as above. When a temperature of the catalyst is low such as immediately after start of the engine, the catalyst should be warmed by continuing an operation of the engine. Therefore, in order to complete warm-up of the catalyst in an early stage, a combustion operation is desirably continued by injecting a fuel.

In controlling a vehicle with a rate of deceleration in accordance with a gear position selected by a user being defined as a target value in deceleration of a hybrid vehicle as described in Japanese Patent Laying-Open No. 10-094107, however, when electric power generated in regeneration exceeds electric power acceptable by a battery, injection of a fuel in the engine should inevitably be stopped in order to apply engine braking. Therefore, warm-up of the catalyst through the combustion operation is interrupted and it may take time until completion of warm-up.

An object of the present disclosure is to provide a hybrid vehicle which controls braking in deceleration of the vehicle without interruption of warm-up of a catalyst in an engine.

A hybrid vehicle according to one aspect of this disclosure includes an engine, a catalyst, a transmission, a power storage device, and a power converter. The catalyst is configured to purify an exhaust gas from the engine during combustion of a fuel. The catalyst is warmed up by the exhaust gas. The transmission includes a rotating electric machine connected to a drive wheel and is configured to transmit motive power between the engine and the drive wheel. The power storage device is configured to store electric power used for driving the rotating electric machine. The power converter is configured to convert electric power bidirectionally between the power storage device and the rotating electric machine. Coasting of the vehicle is started after transition from a first state in which a brake pedal is not operated but an accelerator pedal is operated to a second state in which neither of the brake pedal and the accelerator pedal is operated. The hybrid vehicle further includes an operation device and a controller. The operation device is configured to allow a user to select one deceleration control mode from a plurality of deceleration control modes different in setting of a rate of deceleration of the vehicle during the coasting. The controller is configured to control a rate of deceleration during the coasting with at least one of braking torque resulting from a regenerating operation of the rotating electric machine and friction torque produced in the engine in which combustion of the fuel is stopped, in accordance with a first deceleration control mode selected by the user through the operation device. The controller is configured to notify the user of information inviting the user to switch to a second deceleration control mode in which the rate of deceleration is lower than in the first deceleration control mode, when the first state is set during warm-up of the catalyst and when it is estimated that magnitude of regenerative electric power exceeds upper limit charging power of the power storage device owing to start of the coasting at the rate of deceleration in accordance with the first deceleration control mode at a current vehicle speed.

Thus, with the given information, the user can recognize that the vehicle requests switching to the second deceleration control mode lower in rate of deceleration than the first deceleration control mode. When the user switches to the second deceleration control mode lower in rate of deceleration than the first deceleration control mode in accordance with the given information, magnitude of the rate of deceleration at the time of start of coasting can be made smaller. Consequently, electric power generated in regeneration can be lower than upper limit charging power. Therefore, warm-up of the catalyst can be continued by continuing fuel injection in the engine. In addition, switching to a deceleration control mode lower in rate of deceleration can be made based on an intention of a user. Therefore, uncomfortableness felt by the user at the time of start of coasting can be suppressed.

After the information is given, when switching to the second deceleration control mode is not made and when the coasting is started, the controller controls the rate of deceleration during the coasting with at least the friction torque with warm-up of the catalyst being stopped.

Thus, when switching to the second deceleration control mode lower in rate of deceleration than the first deceleration control mode is not made after the information is given, it is expected that a user desires a rate of deceleration in accordance with the first deceleration control mode as a rate of deceleration at the time of start of coasting. Therefore, by stopping warm-up of the catalyst and controlling a rate of deceleration during coasting with at least friction torque, a rate of deceleration intended by the user can be produced.

The transmission further includes a first rotating electric machine and a planetary gear mechanism. The rotating electric machine serves as a second rotating electric machine. The planetary gear mechanism is mechanically coupled to each of the first rotating electric machine, the second rotating electric machine, and the engine.

Thus, in the vehicle including the planetary gear mechanism which mechanically couples the first rotating electric machine, the second rotating electric machine, and the engine, braking can be controlled during deceleration of the vehicle without interruption of warm-up of the catalyst.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an overall configuration diagram of a hybrid vehicle according to the present embodiment.

FIG. 2 is a diagram for illustrating a shift position set in a shift gate.

FIG. 3 is a diagram for illustrating a configuration of a combination meter.

FIG. 4 is a diagram for illustrating a configuration of an ECU.

FIG. 5 is a diagram for illustrating relation between a vehicle speed and deceleration torque set for each gear position.

FIG. 6 is a flowchart (No. 1) showing one example of control processing performed in the ECU.

FIG. 7 is a flowchart (No. 2) showing one example of control processing performed in the ECU.

FIG. 8 is a timing chart for illustrating an operation of the ECU.

FIG. 9 is a flowchart showing one example of control processing performed in the ECU according to a modification.

FIG. 10 is an overall configuration diagram (No. 1) of the hybrid vehicle according to a modification. FIG. 11 is an overall configuration diagram (No. 2) of the hybrid vehicle according to a modification.

### DETAILED DESCRIPTION

An embodiment of the present disclosure will be described hereinafter in detail with reference to the drawings. The same or corresponding elements in the drawings below have the same reference characters allotted and description thereof will not be repeated in principle.

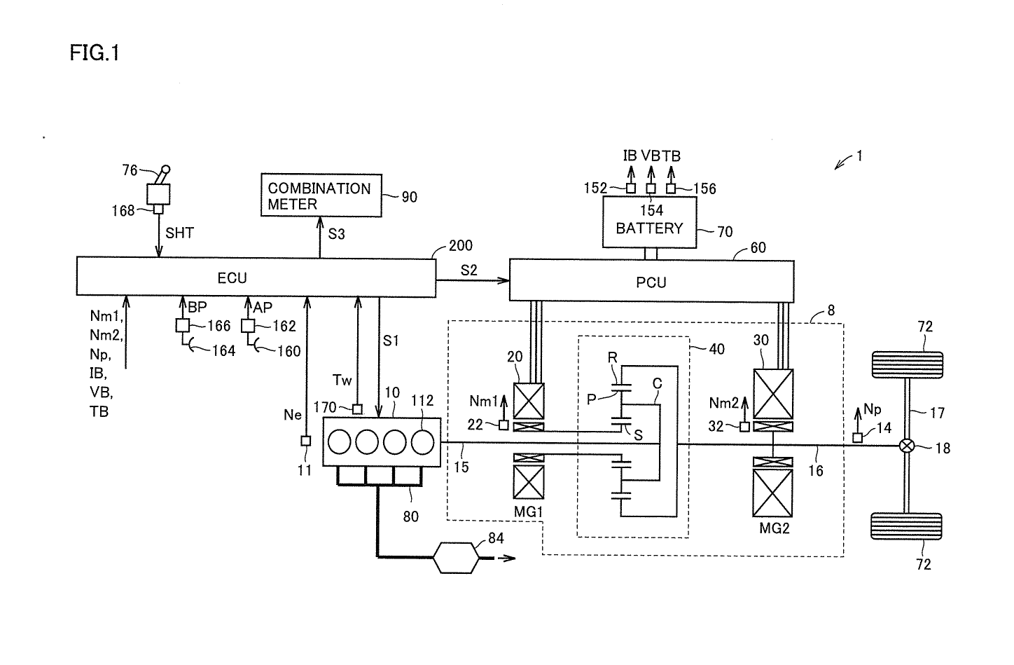

An overall block diagram of a hybrid vehicle 1 (hereinafter simply denoted as a vehicle 1) according to the present embodiment will be described with reference to FIG. 1. Vehicle 1 includes a transmission 8, an engine 10, a driveshaft 17, a differential gear 18, a power control unit (PCU) 60, a battery 70, a drive wheel 72, a shift lever 76, a combination meter 90, an accelerator pedal 160, a brake pedal 164, and an electronic control unit (ECU) 200.

Engine 10 includes a plurality of cylinders 112. One end of an exhaust path 80 is coupled to engine 10. The other end of exhaust path 80 is coupled to a muffler (not shown). A catalyst 84 is provided midway through exhaust path 80.

Engine 10 is an internal combustion engine such as a gasoline engine or a diesel engine and controlled based on a control signal S1 from ECU 200. Engine 10 is provided with a water temperature sensor 170 which detects a temperature Tw of coolant water (hereinafter also denoted as a coolant water temperature) which flows through a coolant water passage in engine 10. Water temperature sensor 170 transmits a signal indicating detected coolant water temperature Tw to ECU 200.

An engine rotation speed sensor 11 is provided at a position in engine 10 opposed to a crankshaft. Engine rotation speed sensor 11 detects a rotation speed Ne of engine 10 (hereinafter denoted as an engine rotation speed). Engine rotation speed sensor 11 transmits a signal indicating detected engine rotation speed Ne to ECU 200.

In the present embodiment, engine 10 includes four cylinders 112 from a first cylinder to a fourth cylinder. An ignition plug (not shown) is provided at a top portion of each of the plurality of cylinders 112.

Engine 10 is provided with a fuel injector (not shown) corresponding to each of the plurality of cylinders 112. The fuel injector may be provided in each of the plurality of cylinders 112 or may be provided in an intake port of each cylinder.

In engine 10 thus constructed, ECU 200 controls an amount of injection of a fuel in each of the plurality of cylinders 112 by allowing injection of an appropriate amount of fuel at appropriate timing into each of the plurality of cylinders 112 or stopping injection of the fuel into the plurality of cylinders 112.

Catalyst 84 provided in exhaust path 80 is a catalyst converter which purifies an exhaust gas by oxidizing an unburnt component or reducing an oxidized component, such components being contained in the exhaust gas emitted from engine 10 in which a fuel is combusted. Catalyst 84 exhibits an appropriate purifying function by being warmed to a temperature equal to or higher than a prescribed temperature by exhaust heat of the exhaust gas.

Transmission 8 includes an input shaft 15, an output shaft 16, a first motor generator (hereinafter denoted as a first MG) 20, a second motor generator (hereinafter denoted as a second MG) 30, and a power split device 40. Input shaft 15 of transmission 8 is connected to the crankshaft of engine 10. Output shaft 16 of transmission 8 is connected to drive wheel 72 with differential gear 18 and driveshaft 17 being interposed.

First MG 20 and second MG 30 are, for example, three-phase alternating-current rotating electric machines. First MG 20 and second MG 30 are driven by PCU 60.

First MG 20 performs a function as a generator (a power generator) which charges battery 70 through PCU 60 by generating electric power by using motive power of engine 10 split by power split device 40. First MG 20 rotates the crankshaft which is the output shaft of engine 10 by receiving electric power from battery 70. First MG 20 thus performs a function as a starter which starts engine 10.

First MG 20 is provided with an MG1 rotation speed sensor 22. MG1 rotation speed sensor 22 detects a rotation speed Nm1 of a rotation shaft of first MG 20. MG1 rotation speed sensor 22 transmits a signal indicating detected rotation speed Nm1 of MG1 to ECU 200.

Second MG 30 performs a function as a drive motor which provides driving force to drive wheel 72 by using at least any one of electric power stored in battery 70 and electric power generated by first MG 20. Second MG 30 performs a function as a generator for charging battery 70 through PCU 60 by using electric power generated in regeneration during braking.

Second MG 30 is provided with an MG2 rotation speed sensor 32. MG2 rotation speed sensor 32 detects a rotation speed Nm2 of a rotation shaft of second MG 30. MG2 rotation speed sensor 32 transmits a signal indicating detected rotation speed Nm2 of MG2 to ECU 200.

Power split device 40 is constructed to be able to split motive power generated by engine 10 into a path to driveshaft 17 via output shaft 16 and a path to first MG 20. Power split device 40 is implemented, for example, by a planetary gear mechanism including a sun gear S, a career C, a ring gear R, and a pinion gear P. Sun gear S is coupled to a rotor of first MG 20. Ring gear R is coupled to a rotor of second MG 30. Pinion gear P is engaged with sun gear S and ring gear R. Career C holds pinion gear P such that pinion gear P can rotate and revolve and is coupled to input shaft 15. Thus, engine 10, first MG 20, and second MG 30 are mechanically connected by power split device 40.

Vehicle 1 thus constructed runs with driving force output from at least one of engine 10 and second MG 30.

PCU 60 converts direct-current power supplied from battery 70 into alternating-current power and drives first MG 20 and second MG 30. PCU 60 converts alternating-current power generated by first MG 20 and second MG 30 into direct-current power, with which battery 70 is charged. For example, PCU 60 includes an inverter (not shown) for direct-current/alternating-current conversion and a converter (not shown) for converting a direct-current voltage between a direct-current link side of the inverter and battery 70.

Battery 70 serves as a power storage device and is a rechargeable direct-current power supply. For example, a secondary battery such as a nickel metal hydride battery or a lithium ion battery is employed as battery 70. As described above, battery 70 is charged with electric power generated by first MG 20 and/or second MG 30, and may be charged with electric power supplied from an external power supply (not shown). Battery 70 is not limited to a secondary battery and may be implemented by a component which can generate a direct-current voltage and can be charged, such as a capacitor.

Battery 70 is provided with a current sensor 152, a voltage sensor 154, and a battery temperature sensor 156. Current sensor 152 detects a current IB of battery 70. Current sensor 152 transmits a signal indicating current IB to ECU 200. Voltage sensor 154 detects a voltage VB of battery 70. Voltage sensor 154 transmits a signal indicating voltage VB to ECU 200. Battery temperature sensor 156 detects a battery temperature TB of battery 70. Battery temperature sensor 156 transmits a signal indicating battery temperature TB to ECU 200.

ECU 200 estimates a state of charge (hereinafter denoted as SOC) of battery 70 based on current IB, voltage VB, and battery temperature TB of battery 70. ECU 200 may estimate an open circuit voltage (OCV), for example, based on a current, a voltage, and a battery temperature, and estimate SOC of battery 70 based on the estimated OCV and a prescribed map. Alternatively, ECU 200 may estimate SOC of battery 70, for example, by summing a charging current and a discharging current of battery 70.

An output shaft rotation speed sensor 14 detects a rotation speed Np of output shaft 16. Output shaft rotation speed sensor 14 transmits a signal indicating detected rotation speed Np to ECU 200. ECU 200 calculates a vehicle speed V based on received rotation speed Np. ECU 200 may calculate vehicle speed V based on rotation speed Nm2 of second MG 30 instead of rotation speed Np.

Accelerator pedal 160 and brake pedal 164 are provided at positions which can be reached for operation by a foot of a user seated at a driver's seat. Accelerator pedal 160 is provided with a stroke sensor 162. Stroke sensor 162 detects an amount of stroke (an amount of press-down) AP of accelerator pedal 160. Stroke sensor 162 transmits a signal indicating amount of stroke AP to ECU 200. A pedal pressure sensor for detecting a pedal pressure applied by a driver of vehicle 1 to accelerator pedal 160 may be employed instead of stroke sensor 162.

Brake pedal 164 is provided with a stroke sensor 166. Stroke sensor 166 detects an amount of stroke (an amount of press-down) BP of brake pedal 164. Stroke sensor 166 transmits a signal indicating amount of stroke BP to ECU 200. A pedal pressure sensor for detecting a pedal pressure applied by a driver of vehicle 1 to brake pedal 164 or a stop lamp switch may be employed instead of stroke sensor 166.

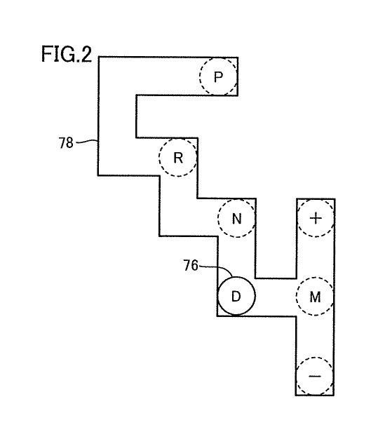

Shift lever 76 is a lever for a user to select a shift position and provided in the vicinity of the driver's seat. As shown in FIG. 2, shift lever 76 is constructed to be movable along a shift gate 78. A path in a predetermined shape in which shift lever 76 can move is formed in shift gate 78, and a plurality of shift positions are brought in correspondence with a plurality of positions in the path.

The plurality of shift positions include, for example, a parking position (hereinafter denoted as a P position), a reverse position (hereinafter denoted as an R position), a neutral position (hereinafter denoted as an N position), a drive position (hereinafter denoted as a D position), a manual shift change position (hereinafter denoted as an M position), a “+” position, and a “−” position.

The P position is a shift position for restricting movement of vehicle 1 during parking. The R position is a shift position for rearward running of vehicle 1. The N position is a shift position for setting transmission 8 in a motive power cut-off state. The D position is a shift position for forward running of vehicle 1. The M position is a shift position for selecting a manual shift change mode. The “+” position is a shift position for a user to indicate up-shifting after the manual shift change mode is selected. The “−” position is a shift position for a user to indicate down-shifting after the manual shift change mode is selected.

A shift position sensor 168 detects a position of shift lever 76 in shift gate 78, among the P position, the R position, the N position, the M position, the “+” position, and the “−” position. Shift position sensor 168 transmits a signal indicating a position SHT of shift lever 76 to ECU 200.

The manual shift change mode is a control mode in which a user is allowed to manually select any gear position among a plurality of gear positions and to control shift change simulating shift change in a gear type automatic transmission in accordance with a selected gear position. In the present embodiment, the gear position includes a first gear, a second gear, a third gear, and a fourth gear.

For each gear position, a lower limit value for engine rotation speed Ne in accordance with vehicle speed V is set. For the lower limit value for the engine rotation speed set for each gear position, a greater value is set as the gear is lower (closer to the first gear) for the same vehicle speed V, and a smaller value is set as the gear is higher (closer to the fourth gear).

When the manual shift change mode is selected, ECU 200 controls engine 10, first MG 20, and second MG 30 such that the engine rotation speed is not lower than the lower limit value for the engine rotation speed corresponding to the selected gear position. Thus, deceleration torque in accordance with a gear position can promptly be generated by using friction of engine 10 while the accelerator is off.

While the accelerator is off and the brake is off, deceleration torque in drive wheel 72 in accordance with vehicle speed V is set for each gear position. Deceleration torque is negative, with torque in a direction of rotation of drive wheel 72 corresponding to a direction of travel of the vehicle being defined as a positive direction. For magnitude of deceleration torque set for each gear position, a greater value is set as the gear is lower (closer to the first gear) for the same vehicle speed V, and a smaller value is set as the gear is higher (closer to the fourth gear). In the present embodiment, deceleration control in accordance with each “gear position” which can be selected in the manual shift change mode corresponds to “a plurality of deceleration control modes” different in setting of a rate of deceleration of vehicle 1 during coasting which is started when transition from a first operation state in which brake pedal 164 is not operated but accelerator pedal 160 is operated to a second operation state in which neither of brake pedal 164 and accelerator pedal 160 is operated is made.

When shift lever 76 is moved to the M position, the manual shift change mode is selected, and when the shift lever is moved from the M position to another shift position, selection of the manual shift change mode is canceled.

After shift lever 76 is moved to the M position, the gear position is up-shifted one by one each time shift lever 76 is moved to the “+” position. The gear position is down-shifted one by one each time shift lever 76 is moved to the “−” position.

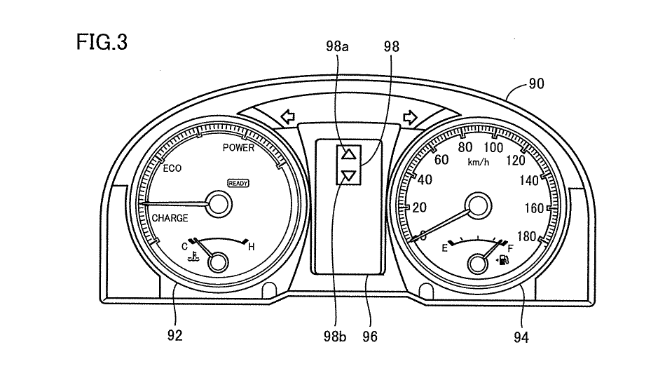

Combination meter 90 is provided at a position visually recognizable by a user seated at the driver's seat (for example, an instrument panel) and shows various types of information relating to vehicle 1. As shown in FIG. 3, combination meter 90 includes a first meter portion 92, a second meter portion 94, and a display area 96.

First meter portion 92 includes an output meter and a water temperature meter. The output meter shows whether battery 70 is being charged or is discharging by showing output from vehicle 1. The water temperature meter shows a cooling temperature Tw of engine 10.

Second meter portion 94 includes a speed meter and a fuel meter. The speed meter shows a speed of vehicle 1. The fuel meter shows an amount of a remaining fuel in a fuel tank.

Display area 96 is provided, for example, by a liquid crystal panel such as a liquid crystal display (LCD). Display area 96 is provided with a shift change display area 98 for notifying a user of information inviting the user to perform a shift change operation while the manual shift change mode has been set. Display area 96 is provided with a region where an indicator, a warning, or a distance of travel is shown, other than shift change display area 98.

In shift change display area 98, for example, a representation for inviting a user to perform a down-shifting shift change operation (hereinafter referred to as a down-shift representation) or a representation for inviting the user to perform an up-shifting shift change operation (hereinafter referred to as an up-shift representation) is shown, or neither of the up-shift representation and the down-shift representation is provided.

Shift change display area 98 includes an up-shift display area 98a where an up-shift representation is provided and a down-shift display area 98b where a down-shift representation is provided.

When an up-shift representation is provided, a triangular up-shift mark is shown in up-shift display area 98a, with one of vertical angles thereof being oriented upward. When a down-shift representation is provided, a triangular down-shift mark is shown in down-shift display area 98b, with one of vertical angles thereof being oriented downward.

Upon receiving a control signal S3 from ECU 200, combination meter 90 provides an up-shift representation or a down-shift representation in shift change display area 98 or perform is representation-off processing for not showing an up-shift representation or a down-shift representation.

ECU 200 generates control signal S1 for controlling engine 10 and outputs generated control signal Si to engine 10. ECU 200 generates a control signal S2 for controlling PCU 60 and outputs generated control signal S2 to PCU 60. ECU 200 generates control signal S3 for controlling combination meter 90 and outputs generated control signal S3 to combination meter 90.

ECU 200 is a controller which controls, by controlling engine 10 and PCU 60, the entire hybrid system, that is, a state of charge and discharge of battery 70 and states of operations of engine 10, first MG 20, and second MG 30, such that vehicle 1 can most efficiently operate.

ECU 200 calculates requested vehicle power corresponding to a shift position, amount of stroke AP of accelerator pedal 160, and vehicle speed V. ECU 200 calculates requested charging and discharging power based on current SOC of battery 70. ECU 200 controls torque of first MG 20 and second MG 30 and output from engine 10 in accordance with the calculated requested power and requested charging and discharging power.

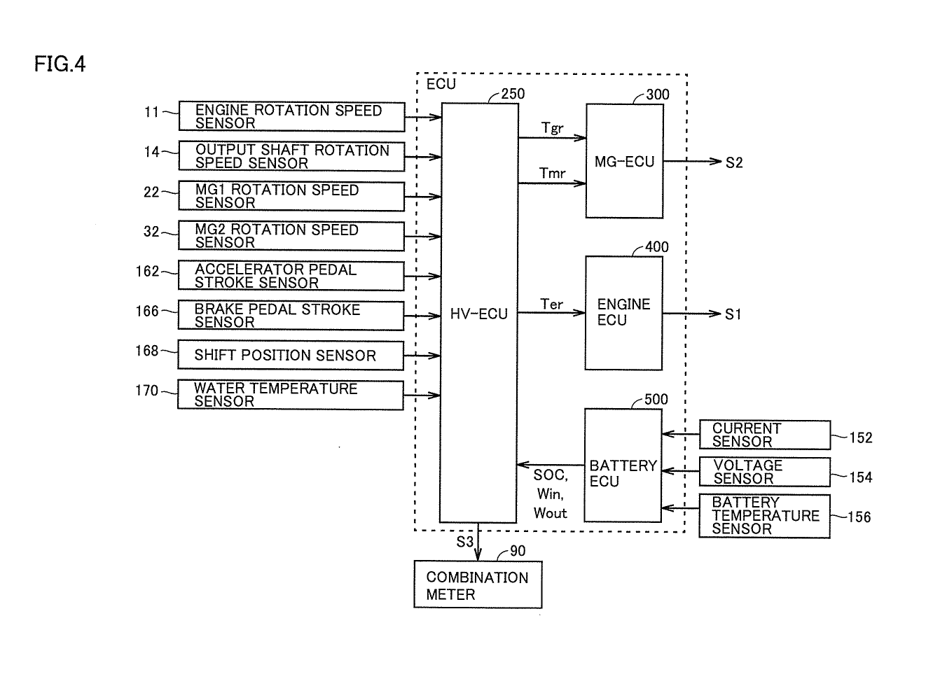

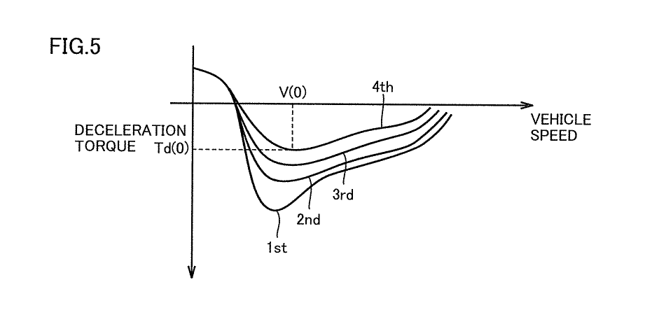

A configuration of ECU 200 will be described below in detail. FIG. 4 is a diagram showing main signals and commands input and output to and from ECU 200 shown in FIG. 1.

ECU 200 includes an HV-ECU 250 for overall control of vehicle 1, an MG-ECU 300 for controlling first MG 20 and the second MG, an engine ECU 400 for controlling engine 10, and a battery ECU 500 for monitoring a state of battery 70.

Referring to FIG. 4, HV-ECU 250 receives a signal from engine rotation speed sensor 11, a signal from output shaft rotation speed sensor 14, a signal from MG1 rotation speed sensor 22, a signal from MG2 rotation speed sensor 32, a signal from stroke sensor 162, a signal from stroke sensor 166, a signal from shift position sensor 168, a signal from water temperature sensor 170, and signals indicating SOC of battery 70, upper limit charging power Win, and upper limit discharging power Wout from battery ECU 500.

HV-ECU 250 generates an engine torque command Ter indicating a target value for output torque of engine 10 based on the signals above and transmits the engine torque command to engine ECU 400. HV-ECU 250 generates a torque command Tgr for first MG 20 and a torque command Tmr for second MG 30 based on the signals above and transmits the torque commands to MG-ECU 300. HV-ECU 250 generates control signal S3 including a representation command for showing various types of information relating to vehicle 1 based on the signals above and transmits the control signal to combination meter 90.

Engine ECU 400 which has received engine torque command Ter from HV-ECU 250 generates control signal Si including a throttle command, an ignition command, and a fuel injection command for controlling an operation of engine 10 and transmits the control signal to engine 10.

MG-ECU 300 generates control signal S2 for controlling an operation of PCU 60 based on torque commands Tgr and Tmr received from HV-ECU 250 and transmits the control signal to PCU 60.

Battery ECU 500 receives a signal from current sensor 152, a signal from voltage sensor 154, and a signal from battery temperature sensor 156. Battery ECU 500 calculates SOC based on results of detection by current sensor 152, voltage sensor 154, and battery temperature sensor 156. Since a method of calculating SOC is as described above, detailed description thereof will not be repeated. Battery ECU 500 calculates upper limit charging power Win and upper limit discharging power Wout based on the calculated SOC and battery temperature TB, by using a map or the like.

The map is set, for example, such that upper limit charging power Win is lower as the SOC is closer to a fully charged state or battery temperature TB is closer to the upper limit temperature or the lower limit temperature. Alternatively, the map is set, for example, such that upper limit discharging power Wout is lower as the SOC is closer to the lower limit value or the battery temperature is closer to the upper limit temperature or the lower limit temperature.

In vehicle 1 configured as above, when warm-up of catalyst 84 has not been completed while engine 10 is operating, ECU 200 controls warm-up of catalyst 84. For example, ECU 200 calculates an estimated value Tc for a temperature of catalyst 84 based on coolant water temperature Tw. ECU 200 determines whether or not calculated estimated value Tc is greater than a threshold value Tc (0) for determining completion of warm-up. When estimated value Tc is equal to or smaller than threshold value Tc (0), ECU 200 determines that warm-up has not been completed and controls warm-up of catalyst 84.

For example, ECU 200 controls engine 10 such that engine rotation speed Ne is equal to or higher than a target rotation speed Ne (0). Target rotation speed Ne (0) is a value set for warming up catalyst 84 in engine 10, and it is, for example, a rotation speed higher than an idle rotation speed. ECU 200 quits warm-up control after a predetermined period of time has elapsed since start of warm-up control. A time period sufficient for at least a temperature of catalyst 84 to be not lower than threshold value Tc (0) as a result of continuation of an operation of engine 10 in which case engine rotation speed Ne is equal to or higher than target rotation speed Ne (0) is set as the predetermined period of time.

Stop control of fuel injection during such warm-up control of engine 10 may interrupt warm-up of catalyst 84. Stop control of fuel injection may be carried out, for example, during deceleration control in which transition from the first operation state in which brake pedal 164 is not operated but accelerator pedal 160 is operated to the second operation state in which neither of brake pedal 164 and accelerator pedal 160 is operated is made. Deceleration control at the time of start of coasting will be described below. When transition from the first operation state to the second operation state is made, ECU 200 sets deceleration torque Td to be applied to vehicle 1 in accordance with a vehicle speed and a gear position.

ECU 200 sets deceleration torque Td to be applied to vehicle 1, for example, based on relation between vehicle speed V and deceleration torque Td set for each gear position shown in FIG. 5. A map shown in FIG. 5 shows one example of relation between vehicle speed V and deceleration torque Td corresponding to each gear position. The abscissa in FIG. 5 represents vehicle speed V and the ordinate in FIG. 5 represents deceleration torque Td.

As shown in FIG. 5, magnitude of deceleration torque Td is greater as the gear is lower (closer to the first gear) for the same vehicle speed, and magnitude is smaller as the gear is higher (closer to the fourth gear). For example, when the fourth gear is selected and vehicle speed V is at V (0), ECU 200 sets Td (0) as deceleration torque Td.

ECU 200 achieves set deceleration torque Td with braking torque resulting from regeneration in second MG 30 (hereinafter denoted as regenerative torque) and braking torque making use of friction rotational resistance of engine 10 (hereinafter denoted as friction torque). Vehicle 1 can decelerate at a rate of deceleration in accordance with a gear position by realizing deceleration torque Ts in accordance with the gear position.

For example, ECU 200 compares magnitude of deceleration power Pd calculated based on deceleration torque Td and vehicle speed V with upper limit charging power Win, and when magnitude of deceleration power is smaller than upper limit charging power Win, the ECU obtains deceleration torque Td with regenerative torque of second MG 30. When magnitude of deceleration power is greater than upper limit charging power Win, ECU 200 obtains deceleration torque Td with friction torque of engine 10 instead of or in addition to regenerative torque of second MG 30.

When deceleration torque Td is obtained with regenerative torque of second MG 30, ECU 200 sets a torque command value for first MG 20 to substantially zero and controls regenerative torque of second MG 30 such that deceleration torque Td is generated in the drive wheel of vehicle 1.

When deceleration torque Td is obtained with friction torque of engine 10, ECU 200 sets the lower limit value for engine rotation speed Ne set in accordance with vehicle speed V as a target engine rotation speed and carries out power running control or regeneration control in first MG 20 while the ECU stops fuel injection in engine 10. When electric power is consumed in power running control of first MG 20, ECU 200 controls regeneration in second MG 30 so as to compensate for consumed electric power. When electric power is generated in regeneration control of first MG 20, ECU 200 consumes generated electric power in power running control in second MG 30. By increasing a rotation speed of first MG 20, friction torque of engine 10 is applied in a direction of rotation of ring gear R corresponding to a direction reverse to a direction of travel of vehicle 1, to thereby obtain deceleration torque Td.

When vehicle 1 is controlled with deceleration torque in accordance with a gear position selected by the user in deceleration of vehicle 1 being set as the target value, however, electric power generated in regeneration may exceed electric power acceptable by battery 70. In such a case, engine braking should be applied and fuel injection in engine 10 should inevitably be stopped. Therefore, warm-up of catalyst 84 through a combustion operation is interrupted and it may take time until warm-up is completed.

In the present embodiment, ECU 200 estimates regenerative electric power when transition to the second operation state is made in the first operation state. When battery 70 cannot accept estimated regenerative electric power, ECU 200 notifies a user of information inviting the user to up-shift a gear position.

Thus, the user can recognize based on the given information that the vehicle requests switching to a gear position lower in rate of deceleration than the current gear position. When the user switches to a gear position lower in rate of deceleration than the current gear position in accordance with the given information, magnitude of a rate of deceleration at the time of start of coasting can be decreased. Consequently, electric power generated in regeneration can be lower than upper limit charging power. Therefore, fuel injection in engine 10 can be continued and thus warm-up of catalyst 84 can be continued.

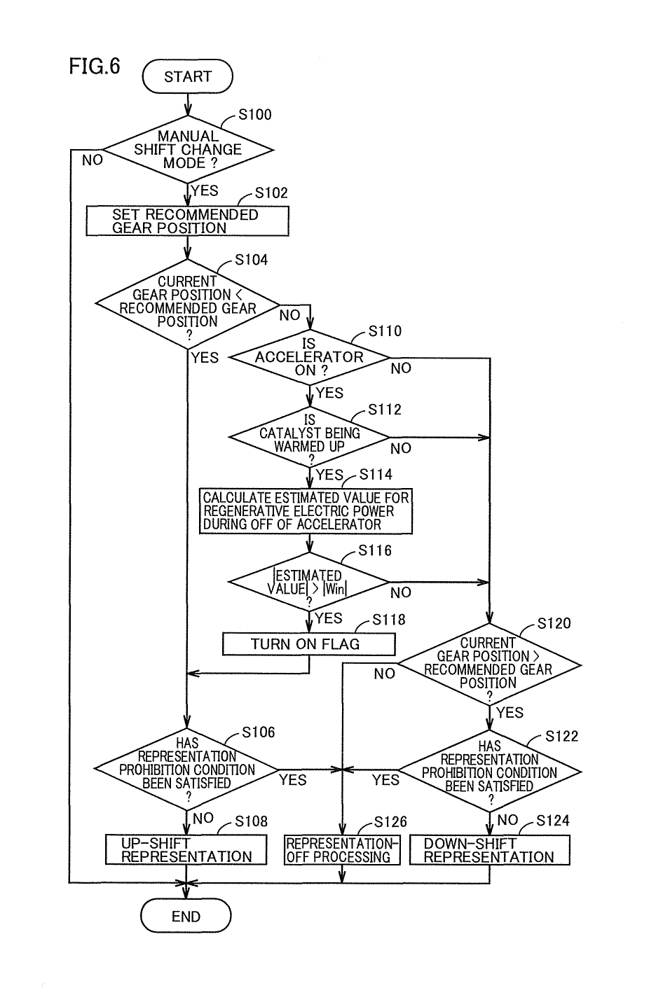

FIG. 6 is a flowchart showing control processing for providing an up-shift representation and a down-shift representation inviting shift change in the manual shift change mode. This flowchart is repeatedly executed with a prescribed period.

In a step (hereinafter a step being denoted as S) 100, ECU 200 determines whether or not the manual shift change mode has been selected. For example, when shift lever 76 is at a position corresponding to the manual shift change mode, ECU 200 determines that the manual shift change mode has been selected and the process proceeds to S102.

In S102, ECU 200 sets a recommended gear position. ECU 200 sets any one of the first gear to the fourth gear as the recommended gear position based on vehicle speed V and amount of stroke AP of accelerator pedal 160. ECU 200 sets the recommended gear position, for example, by using a map showing relation among vehicle speed V, amount of stroke AP of accelerator pedal 160, and the recommended gear position. For example, the map is a map in which an optimal gear position in achieving improvement in fuel efficiency is set in accordance with vehicle speed V and amount of stroke AP of accelerator pedal 160, with vehicle speed V and amount of stroke AP of accelerator pedal 160 being defined as parameters. The map is adapted through experiments or in terms of design and stored in a memory contained in ECU 200.

When the recommended gear position is set in S102, ECU 200 determines in S104 whether or not the current gear position is lower than the recommended gear position. When the current gear position is lower than the recommended gear position, it is determined that up-shifting is necessary and the process proceeds to S106.

ECU 200 determines in S106 whether or not a condition for prohibiting an up-shift representation has been satisfied. The condition for prohibiting an up-shift representation includes, for example, such a condition that there is a failed portion in vehicle 1 and such a condition that an engine rotation speed should be maintained due to noise or an operation of auxiliary machinery. When the condition for prohibiting an up-shift representation has not been satisfied (NO in S106), it is determined that an up-shift representation can be provided and the process proceeds to S108. In S108, ECU 200 provides an up-shift representation.

When it is determined in S104 that the current gear position is equal to or higher than the recommended gear position (NO in S104), ECU 200 determines in S110 whether or not the accelerator is on. For example, when amount of stroke AP of accelerator pedal 160 is greater than a threshold value AP (0), ECU 200 determines that the accelerator is on.

When it is determined that the accelerator is on (YES in S110), ECU 200 determines in S112 whether or not the catalyst is being warmed up. For example, when estimated value Tc for a temperature of catalyst 84 is lower than threshold value Tc (0) or when a predetermined period of time has not elapsed since start of warm-up control, ECU 200 determines that the catalyst is being warmed up and the process proceeds to S114.

In S114, before turn-off of the accelerator, ECU 200 calculates an estimated value for regenerative electric power for obtaining deceleration torque Td with regenerative torque, with turn-off of the accelerator being assumed. For example, ECU 200 calculates deceleration torque Td based on current vehicle speed V and the map shown in FIG. 5 and calculates deceleration power Pd based on current vehicle speed V and deceleration torque Td. ECU 200 calculates calculated deceleration power Pd as the estimated value for regenerative electric power.

ECU 200 determines in S116 whether or not magnitude of the estimated value for regenerative electric power is greater than upper limit charging power Win. When it is determined that magnitude of the estimated value for regenerative electric power is greater than upper limit charging power Win (YES in S116), it is determined that battery 70 cannot accept regenerative electric power comparable to deceleration power Pd and the process proceeds to S118.

In S118, ECU 200 sets a flag indicating an up-shift representation for the purpose to continue warm-up of catalyst 84 to on and the process proceeds to S106.

When it is determined in S110 that the accelerator is not on (NO in S110), ECU 200 determines in S120 whether or not the current gear position is higher than the recommended gear position. When the current gear position is higher than the recommended gear position, it is determined that down-shifting is necessary and the process proceeds to S122. ECU 200 determines in S122 whether or not a condition for prohibiting a down-shift representation has been satisfied. The condition for prohibiting a down-shift representation includes, for example, such a condition that there is a failed portion in vehicle 1 and such a condition that an engine rotation speed should be maintained due to noise or an operation of auxiliary machinery. When the condition for prohibiting a down-shift representation has not been satisfied (NO in S122), it is determined that a down-shift representation can be provided and the process proceeds to S124. In S124, ECU 200 provides a down-shift representation.

When the current gear position is the same as the recommended gear position (NO in S120), when the condition for prohibiting an up-shift representation has been satisfied (YES in S106), or when the condition for prohibiting a down-shift representation has been satisfied (YES in S122), ECU 200 performs representation-off processing in S126. In representation-off processing, ECU 200 no longer allows a down-shift representation when the down-shift representation is being provided, and no longer allows an up-shift representation when the up-shift representation is being provided. When it is determined in S100 that the manual shift change mode has not been set (NO in S100), ECU 200 quits the process.

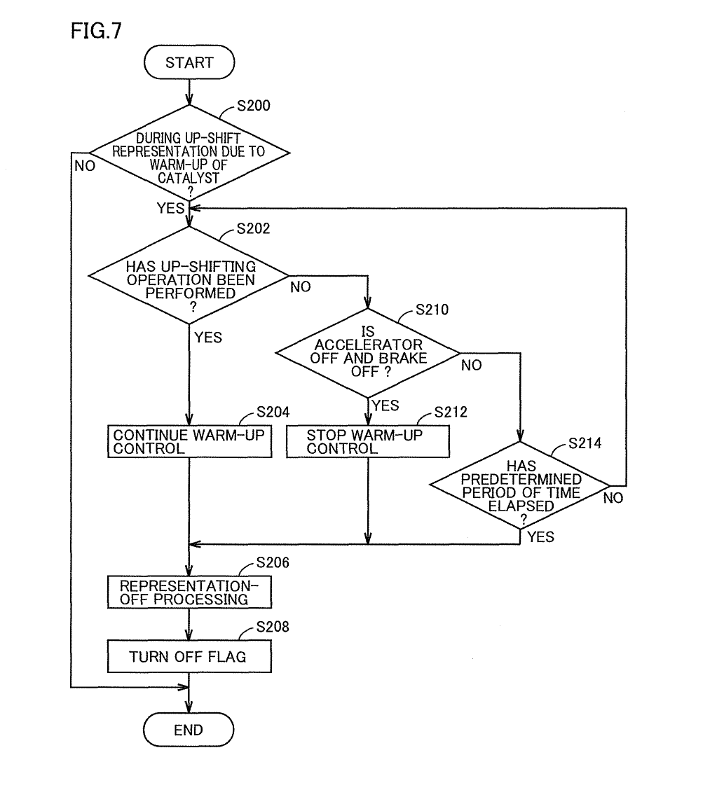

FIG. 7 shows a flowchart of control processing performed when an up-shift representation for the purpose to continue warm-up of catalyst 84 is provided.

ECU 200 determines in S200 whether or not an up-shift representation for warm-up of the catalyst is being provided. When the flag is set to on in S118 in the flowchart in FIG. 6, ECU 200 determines that the up-shift representation for warm-up of the catalyst is being provided and the process proceeds to S202.

ECU 200 determines in S202 whether or not a user has performed an up-shifting operation. ECU 200 determines that the user has performed the up-shifting operation (YES in S202), for example, based on movement of shift lever 76 to the “+” position and the process proceeds to S204.

ECU 200 continues warm-up control in S204, performs representation-off processing in S206, and sets the flag to off in S208. When the user has not performed the up-shifting operation (NO in S202), ECU 200 determines in S210 whether or not the accelerator is off and the brake is off. ECU 200 determines that the accelerator is off, for example, when amount of stroke AP of accelerator pedal 160 is equal to or smaller than threshold value AP (0). Similarly, ECU 200 determines that the brake is off, for example, when amount of stroke BP of brake pedal 164 is equal to or smaller than a threshold value BP (0).

When it is determined that the accelerator is off and the brake is off (YES in S210), in S212, ECU 200 stops warm-up control and permits stop of fuel injection, and the process proceeds to S206. When the accelerator remains on (NO in S210), ECU 200 determines in S214 whether or not a predetermined period of time has elapsed since start of the up-shift representation for warm-up of the catalyst. Until the predetermined period of time elapses (NO in S214), ECU 200 determines again in S202 whether or not the up-shifting operation has been performed. When the predetermined period of time has elapsed (YES in S214), the process proceeds to S206. When it is determined in S200 that the up-shift representation for warm-up of the catalyst is not being provided (NO in S200), ECU 200 quits the process.

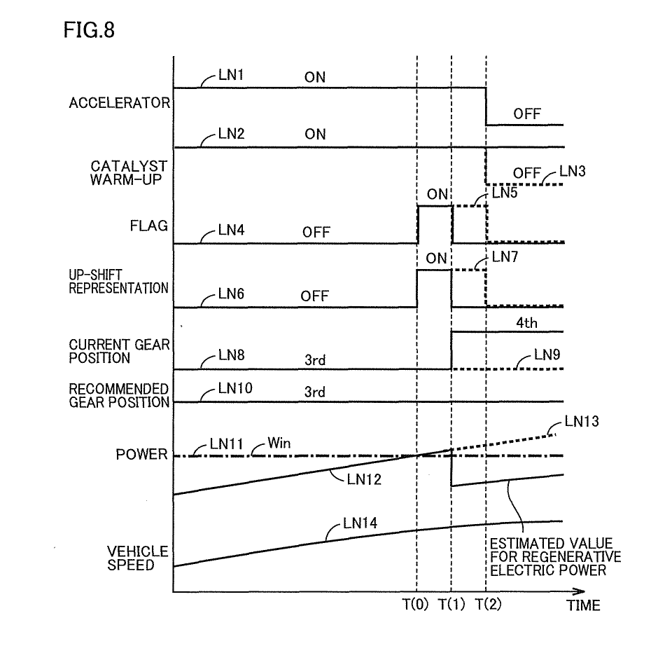

An operation of ECU 200 mounted on vehicle 1 according to the present embodiment based on the structure and the flowchart as above will be described with reference to FIG. 8. The abscissa in FIG. 8 represents time. The ordinate in FIG. 8 shows a state of operation of the accelerator pedal, a state of execution of warm-up control of the catalyst, a state of the flag indicating that an up-shift representation for warm-up of the catalyst is being provided, a state of execution of the up-shift representation, a current gear position, a recommended gear position, upper limit charging power Win, an estimated value for regenerative electric power, and a vehicle speed.

A condition in which a driver selects the manual shift change mode, fixes a gear position at the third gear, and presses accelerator pedal 160 by a certain amount, and vehicle 1 gradually accelerates is assumed as the initial state. It is assumed here that engine 10 has just been started and warm-up of catalyst 84 has not been completed.

Therefore, as shown with a solid line LN1 in FIG. 8, the accelerator is on. As shown with a solid line LN2 in FIG. 8, warm-up of catalyst 84 is being controlled. As shown with a solid line LN4 in FIG. 8, the flag indicating that an up-shift representation for warm-up of the catalyst is being provided is off. As shown with a solid line LN6 in FIG. 8, the up-shift representation is not being provided. As shown with a solid line LN8 in FIG. 8, the current gear position is set to the third gear. As shown with a solid line LN10 in FIG. 8, the third gear is set as the recommended gear position based on a current state of running. At this time point, upper limit charging power Win shown with a chain dotted line LN11 in FIG. 8 is higher than an estimated value for regenerative electric power shown with a solid line LN12 in FIG. 8. As shown with a solid line LN14 in FIG. 8, vehicle speed V is at a value indicating that vehicle 1 is running.

Upper limit charging power Win is constant for the sake of convenience of illustration. As shown with solid line LN14, increase in vehicle speed V with lapse of time is described by way of example. Increase also in deceleration torque Td with increase in vehicle speed V is assumed.

For example, with increase in deceleration torque Td which is set during off of the accelerator with increase in vehicle speed V with lapse of time as shown with solid line LN14, the estimated value for regenerative electric power also increases as shown with solid line LN12.

Since the manual shift change mode has been selected (YES in S100) and the third gear has been set as the recommended gear position (S102), the current gear position is determined as being equal to or higher than the recommended gear position (NO in S104). Therefore, whether or not the accelerator is on is determined (S110).

Since the accelerator is on (YES in S110) as shown with solid line LN1 and warm-up of catalyst 84 is being controlled (S112) as shown with solid line LN2, the estimated value for regenerative electric power during off of the accelerator is calculated (S114).

When magnitude of the calculated estimated value for regenerative electric power is determined as being greater than upper limit charging power Win (YES in S116) as shown with chain dotted line LN11 and solid line LN12 at time T (0), the flag is set to on as shown with solid line LN4 (S118). Thereafter, when a condition for prohibiting the up-shift representation has not been satisfied (NO in S106), the up-shift representation is provided (S108) as shown with solid line LN6.

When a user moves shift lever 76 to the “+” position in accordance with the up-shift representation at time T (1), the current gear position is up-shifted from the third gear to the fourth gear as shown with solid line LN8.

Since the up-shift representation due to warm-up of the catalyst has been provided (YES in S200) and the user has up-shifted the gear (S202), warm-up control of catalyst 84 is continued (S204) as shown with solid line LN2. Then, representation-off processing is performed for the up-shift representation (S206) as shown with solid line LN6, and the flag is set to off (S208) as shown with solid line LN4.

When the current gear position is equal to or higher than the recommended gear position (NO in S104) as shown with solid lines LN8 and LN10 at time T (2) and even when the user performs an operation to turn off the accelerator (NO in S110) as shown with solid line LN1, magnitude of the estimated value for regenerative electric power is smaller than upper limit charging power Win as shown with chain dotted line LN11 and solid line LN12. Therefore, warm-up can continuously be controlled.

When the user does not perform an operation for up-shifting from the third gear to the fourth gear as shown with a dashed line LN9 in FIG. 8 at time T (1), the up-shift representation is continued also after time T (1) as shown with a dashed line LN7 in FIG. 8. Since the current gear position remains at the third gear, the estimated value for regenerative electric power continues to increase as shown with a dashed line LN13.

When the accelerator is turned off (YES in S210) as shown with solid line LN1 without the operation for up-shifting (NO in S202) during the up-shift representation for warm-up of the catalyst (YES in S200), warm-up of the catalyst is stopped (S212) as shown with a dashed line LN3 in FIG. 8. Then, representation-off processing is performed for the up-shifting representation (S206) as shown with dashed line LN7, and the flag is set to off as shown with a dashed line LN5. Here, at least fuel injection in engine 10 is stopped and deceleration control accompanying braking with friction torque of engine 10 is carried out.

As set forth above, according to the vehicle according to the present embodiment, the user can recognize that vehicle 1 requests switching to a gear position lower in rate of deceleration than the current gear position based on information given to the user (up-shift representation). When the user switches to the gear position lower in rate of deceleration than the current gear position in accordance with the given information, magnitude of a rate of deceleration at the time of start of coasting can be decreased. Consequently, electric power generated in regeneration can be lower than upper limit charging power. Therefore, warm-up of catalyst 84 can continue by continuing fuel injection in engine 10. Since switching to the deceleration control mode lower in rate of deceleration is made based on an intention of a user, uncomfortableness felt by the user at the time of start of coasting is suppressed. Therefore, a hybrid vehicle in which braking during deceleration of the vehicle is controlled without interruption of warm-up of the catalyst of the engine can be provided.

When switching to a gear position lower in deceleration torque than the current gear position is not made after the up-shift representation, the user is expected to desire deceleration torque corresponding to the current gear position as deceleration torque at the time of start of coasting. Therefore, deceleration torque intended by the ᵤser can be generated by stopping warm-up of catalyst 84 and controlling a rate of deceleration during coasting with braking torque resulting from regeneration and friction torque.

A modification will be described below.

In the embodiment described above, the up-shift representation is provided when an estimated value for regenerative electric power is greater than upper limit charging power Win during on of the accelerator in the manual shift change mode. When an estimated value for regenerative electric power during off of the accelerator is greater than upper limit charging power Win during on of the accelerator while a shift position (for example, a brake position (hereinafter denoted as a B position)) at which deceleration torque during deceleration is set to be greater than deceleration torque at the D position is selected, a representation inviting the user to change to the D position may be provided. In this case, deceleration control during off of the accelerator and off of the brake with the D position having been selected and deceleration control during off of the accelerator and off of the brake with the B position having been selected correspond to “a plurality of deceleration control modes.”

By doing so as well, braking during deceleration of the vehicle can be controlled without interruption of warm-up of the catalyst of the engine.

When an estimated value for regenerative electric power is greater than upper limit charging power Win in the embodiment described above, deceleration torque is obtained with friction torque of engine 10 instead of or in addition to regeneration torque by way of example. Deceleration torque, however, may be obtained, for example, only with friction torque of engine 10.

In the embodiment described above, estimated value Tc for a temperature of the catalyst is calculated based on coolant water temperature Tw, and warm-up of catalyst 84 is controlled when calculated estimated value Tc is equal to or smaller than threshold value Tc (0). For example, however, when coolant water temperature Tw is equal to or lower than a threshold value Tw (0) corresponding to threshold value Tc (0), warm-up of catalyst 84 may be controlled.

In the embodiment described above, the up-shift representation or the down-shift representation is given by using a triangular mark as shown in FIG. 3. The up-shift representation or the down-shift representation may be given, for example, by using an arrow mark, showing a gear position to be set, or giving a gear position to be set through a voice instruction.

In the embodiment described above, in the manual shift change mode, shift lever 76 is used to perform up-shifting or down-shifting. The up-shifting operation and the down-shifting operation, however, may be performed, for example, by using a paddle switch for up-shifting and a paddle switch for down-shifting provided in a steering wheel. In the embodiment described above, ECU 200 includes HV-ECU 250, MG-ECU 300, engine ECU 400, and battery ECU 500. ECU 200, however, may be one integrated ECU.

In the embodiment described above, the up-shift representation is provided when magnitude of an estimated value for regenerative electric power is greater than upper limit charging power Win while the accelerator is on in the manual shift change mode. The up-shift representation, however, may be provided, for example, when an estimated value for regenerative electric power is greater than upper limit charging power Win and the current gear position is set to the upper limit gear position while the accelerator is on in a sequential shift mode (hereinafter denoted as an S mode) instead of the manual shift change mode.

The S mode is a control mode in which a user can select the upper limit gear position. The S mode is different from the manual shift change mode in that a speed is automatically changed with the selected gear position being defined as the upper limit. For example, when the user selects the fourth gear while the S mode has been selected, ECU 200 can select an optimal gear position from among the first gear to the fourth gear. Similarly, when the user selects the third gear while the S mode has been selected, ECU 200 can select an optimal gear position from among the first gear to the third gear. When the user selects the second gear while the S mode has been selected, ECU 200 can select an optimal gear position out of the first gear and the second gear. When the user selects the first gear while the S mode has been selected, ECU 200 can select only the first gear. In this case, deceleration control during off of the accelerator and off of the brake in accordance with each “gear position” which can be selected in the S mode corresponds to “a plurality of deceleration control modes.”

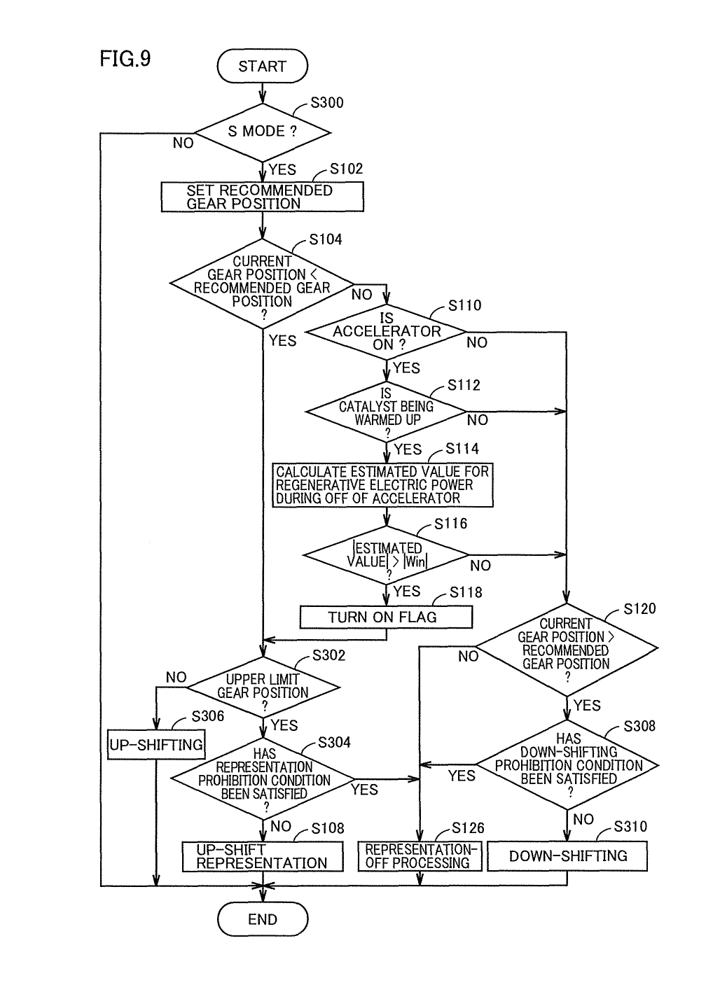

FIG. 9 is a flowchart showing control processing for providing an up-shift representation and a down-shift representation inviting a user to change shift in the S mode. This flowchart is repeatedly executed with a prescribed period.

Processing in the flowchart in FIG. 9 similar to the processing in the flowchart in FIG. 6 has the same step number allotted. Therefore, detailed description thereof will not be repeated.

ECU 200 determines in S300 whether or not the S mode has been set. For example, when a position of shift lever 76 is at a position corresponding to the S mode, ECU 200 determines that the S mode has been selected and the process proceeds to S102. The position corresponding to the S mode is, for example, a position the same as the position (the M position) corresponding to the manual shift change mode in shift gate 78 described with reference to FIG. 2.

When the current gear position is lower than the recommended gear position in S104 (YES in S104), ECU 200 determines in S302 whether or not the current gear position is the upper limit gear position. When the current gear position is the upper limit gear position (YES in S302), an up-shifting operation by the user is necessary and hence the process proceeds to S304. ECU 200 determines in S304 whether or not a condition for prohibiting the up-shift representation has been satisfied. Since the condition for providing the up-shift representation is the same as the condition for prohibiting the up-shift representation in the manual shift change mode, detailed description thereof will not be repeated. When the condition for prohibiting the up-shift representation has not been satisfied (NO in S304), ECU 200 provides the up-shift representation.

When the current gear position is not the upper limit gear position (NO in S302), up-shifting can be performed. Therefore, ECU 200 performs up-shifting in S306.

When the current gear position is higher than the recommended gear position (YES in S120), ECU 200 determines whether or not the condition for prohibiting down-shifting has been satisfied. The condition for prohibiting down-shifting includes, for example, such a condition that vehicle 1 includes a failed portion. When it is determined that the condition for prohibiting down-shifting has not been satisfied (NO in S308), ECU 200 performs down-shifting because down-shifting to a gear equal to or lower than the upper limit gear position is permitted in the S mode.

By doing so as well, braking during deceleration of the vehicle can be controlled without interruption of warm-up of the catalyst of the engine.

In the embodiment described above, transmission 8 includes first MG 20, second MG 30, and power split device 40 mechanically connecting first MG 20, second MG 30, and engine 10 as shown in FIG. 1. So long as the transmission includes at least a rotating electric machine connected to drive wheel 72 and motive power can be transmitted between engine 10 and drive wheel 72, the transmission is not particularly limited to the construction shown in FIG. 1.

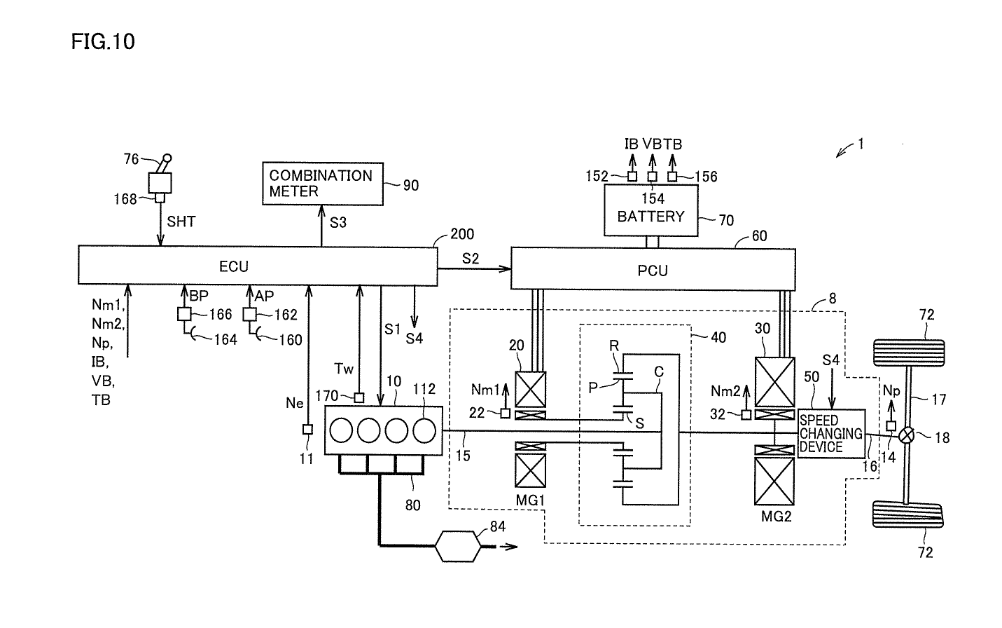

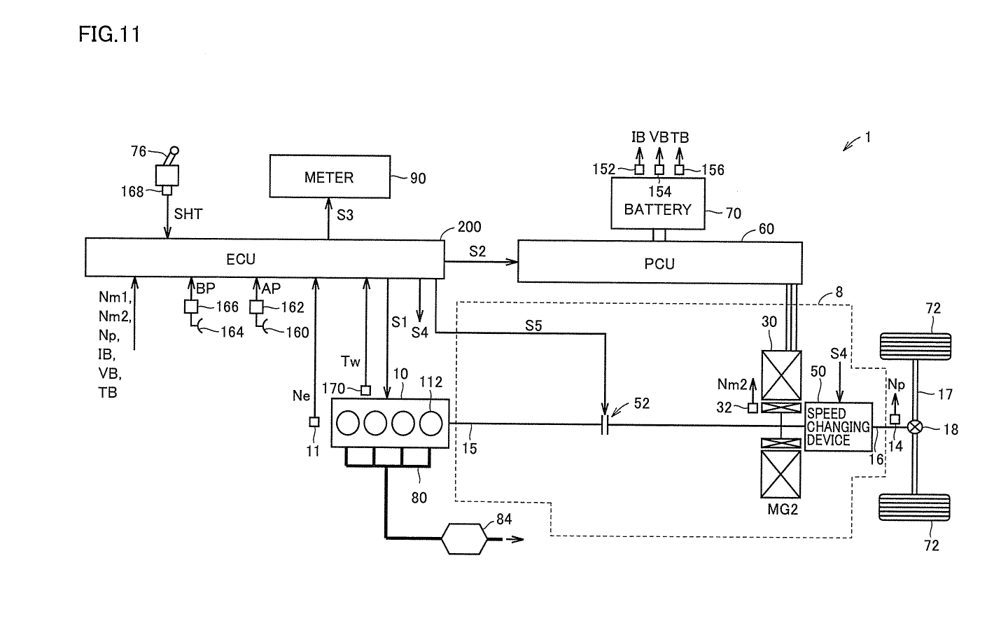

For example, as shown in FIG. 10, transmission 8 may be constructed such that a speed changing device 50 is interposed in a driveshaft between second MG 30 and differential gear 18. Speed changing device 50 is an automatic transmission including, for example, a plurality of gear positions different in gear ratio. In speed changing device 50, shift change is controlled based on a control signal S4 from ECU 200. Speed changing device 50 may be a gear type automatic transmission or may be a continuously variable automatic transmission having a manual shift change mode in which a plurality of discretely and simulatively set gear ratios are set as gear positions. In this case, deceleration torque is set for each gear position. Deceleration torque set for each gear position is obtained with at least one of friction torque of engine 10 and braking torque resulting from regeneration in second MG 30. Since features other than speed changing device 50 shown in FIG. 10 are the same as those in FIG. 1, detailed description thereof will not be repeated.

Alternatively, as shown in FIG. 11, transmission 8 may be provided with a clutch 52 instead of first MG 20 and power split device 40 among the features in vehicle 1 shown in FIG. 10. Clutch 52 is, for example, a dry clutch, and can be switched to any of an engaged state and a disengaged state based on engagement control with the use of a not-shown clutch actuator. Engagement of clutch 52 is controlled based on a control signal S5 from ECU 200. In such vehicle 1, while clutch 52 is engaged, deceleration torque set for each gear position is obtained by making use of at least one of friction torque of engine 10 and braking torque resulting from regeneration in second MG 30. While clutch 52 is disengaged, deceleration torque set for each gear position is obtained by making use of braking torque resulting from regeneration in second MG 30. Since features other than clutch 52 and speed changing device 50 shown in FIG. 11 are the same as those in FIG. 1, detailed description thereof will not be repeated.

The modification above may be implemented by combining the entirety or a part thereof.

Though the embodiment of the present disclosure has been described, it should be understood that the embodiment disclosed herein is illustrative and non-restrictive in every respect. The scope of the present subject matter is defined by the terms of the claims and is intended to include any modifications within the scope and meaning equivalent to the terms of the claims.

What is claimed is:

1. A hybrid vehicle comprising:
an engine;
a catalyst configured to purify an exhaust gas from the engine during combustion of a fuel, the catalyst being warmed up by the exhaust gas;
a transmission including a rotating electric machine connected to a drive wheel, and configured to transmit motive power between the engine and the drive wheel;
a power storage device configured to store electric power used for driving the rotating electric machine; and
a power converter configured to convert electric power bidirectionally between the power storage device and the rotating electric machine,
coasting of the vehicle being started after transition from a first state in which a brake pedal is not operated but an accelerator pedal is operated to a second state in which neither of the brake pedal and the accelerator pedal is operated,
the hybrid vehicle comprising:
an operation device configured to allow a user to select one deceleration control mode from a plurality of deceleration control modes different in setting of a rate of deceleration of the vehicle during the coasting; and
a controller configured to control a rate of deceleration during the coasting with at least one of (i) braking torque resulting from a regenerating operation of the rotating electric machine and (ii) friction torque produced in the engine in which combustion of the fuel is stopped, in accordance with a first deceleration control mode selected by the user through the operation device,
the controller being configured to notify the user of information inviting the user to switch to a second deceleration control mode in which the rate of deceleration is lower than in the first deceleration control mode, when the first state is set during warm-up of the catalyst and when it is estimated that magnitude of regenerative electric power exceeds upper limit charging power of the power storage device owing to start of the coasting at the rate of deceleration in accordance with the first deceleration control mode at a current vehicle speed.

2. The hybrid vehicle according to claim 1, wherein
after the information is given, when switching to the second deceleration control mode is not made and when the coasting is started, the controller controls the rate of deceleration during the coasting with at least the friction torque with warm-up of the catalyst being stopped.

3. The hybrid vehicle according to claim 1, wherein
the transmission further includes a first rotating electric machine and a planetary gear mechanism,
the rotating electric machine serves as a second rotating electric machine, and
the planetary gear mechanism is mechanically coupled to each of the first rotating electric machine, the second rotating electric machine, and the engine.
